(19) United States
(12) Patent Application Publication
(10) Pub. No.: US 2026/0063182 A1
(43) Pub. Date: Mar. 5, 2026

(54) BRAKE PAD HAVING SHIM RETENTION FEATURES

(71) Applicant: Robert Bosch GmbH, Stuttgart (DE)

(72) Inventors: Mark Phipps, Wayne, IL (US); Eduardo Alejandro Rodriguez Merjil, Juarez (MX); Jesus Osvaldo Alvarez Morales, Juarez (MX); Ismael Cabanillas Lespron, Juarez (MX); Carlos Arturo Alvarado Munoz, Juarez (MX)

(21) Appl. No.: 19/311,307

(22) Filed: Aug. 27, 2025

Related U.S. Application Data
(60) Provisional application No. 63/689,354, filed on Aug. 30, 2024.

(51) Int. Cl. F16D 65/097; F16D 65/00

(52) U.S. Cl. CPC F16D 65/0971; F16D 65/0006

(57) ABSTRACT

A brake pad assembly comprising a pad shim and backing plate. The pad shim and backing plate comprise a matching pair of retaining features that optimize assembly of the brake pad assembly. In some embodiments, the pad shim comprises one or more snap latches and the backing plate comprises a matching number of latch catches. In some embodiments, the pad shim comprises one or more springform tabs and the backing plate comprises a matching number of tab recesses. The retaining features may comprise or exhibit geometric shapes to optimize retention of the pad shim and the backing plate during coupling.

### TECHNICAL FIELD

This disclosure relates to the use and assembly of automotive brake pads.

### BACKGROUND

Automotive brake pads comprise consumable materials in the form of pad shims, which create friction with the rotor of the automobile during use. Pad shims are typically coupled to a stiffer backing plate for ease of installation in the vehicle, and also even application of braking force across the surface of the pad shim.

Conventional brake pads couple the pad shim and the backing plate during manufacture using a stamping operation. The stamping is energy-intensive and requires specialized devices to complete the coupling. What is desired is a form of brake pad with a pad shim that can be coupled to the backing plate inexpensively and easily.

### SUMMARY

One aspect of this disclosure is directed to a brake pad assembly comprising a pad shim and a backing plate. The pad shim has a body and a snap latch extending from the body. The backing plate has a latch catch. The snap latch defines a recess with a first geometric shape, and the latch catch has a second geometric shape. The pad shim is coupled to the backing plate by engaging the latch catch with the recess, such that the recess receives the latch catch during coupling. In some embodiments, the snap latch extends from an outer edge of the pad shim. In some embodiments, the latch catch extends from an outer edge of the backing plate.

Another aspect of this disclosure is directed to a brake pad assembly comprising a pad shim and a backing plate. The pad shim has a body and a springform tab extending from the body. The backing plate has a tab recess. The springform tab defines a protrusion with a first geometric shape, and the tab recess has a second geometric shape. The pad shim is coupled to the backing plate by engaging the springform tab with the tab recess, such that the tab recess receives the protrusion during coupling. In some embodiments, the springform tab extends from an outer edge of the pad shim. In some embodiments, the tab recess is defined along an outer edge of the backing plate.

The above aspects of this disclosure and other aspects will be explained in greater detail below with reference to the attached drawings.

### BRIEF DESCRIPTION OF THE DRAWINGS

FIG. 1 is an illustration of a brake pad assembly.

FIG. 2 is an exploded view of the brake pad assembly of FIG. 1.

FIG. 3 is a close-up view of some features of an alternative embodiment of the brake pad assembly of FIG. 1.

FIG. 4 is a close-up view of some features of an alternative embodiment of the brake pad assembly of FIG. 1.

FIG. 5 is a close-up view of some features of an alternative embodiment of the brake pad assembly of FIG. 1.

FIG. 6 is an illustration of a brake pad assembly.

FIG. 7 is an exploded view of the brake pad assembly of FIG. 1.

FIG. 8 is a close-up view of some features of an alternative embodiment of the brake pad assembly of FIG. 6.

FIG. 9 is a close-up view of some features of an alternative embodiment of the brake pad assembly of FIG. 6.

FIG. 10 is a close-up view of some features of an alternative embodiment of the brake pad assembly of FIG. 6.

FIG. 11 is a close-up view of some features of an alternative embodiment of the brake pad assembly of FIG. 6.

FIG. 12 is a close-up view of some features of an alternative embodiment of the brake pad assembly of FIG. 6.

FIG. 13 is a close-up view of some features of an alternative embodiment of the brake pad assembly of FIG. 6.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

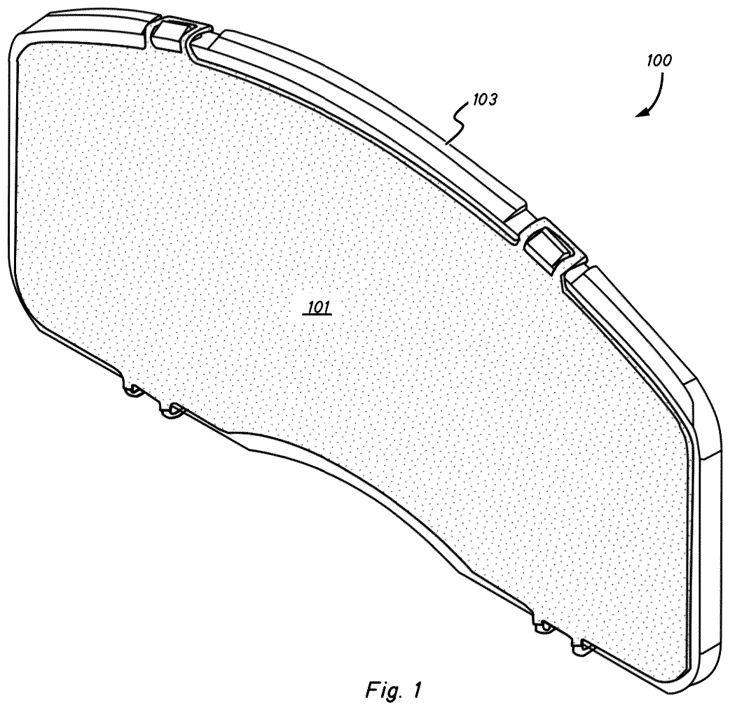

FIG. 1 is an illustration of a brake pad assembly 100. Brake pad assembly 100 comprises a pad shim 101 and a backing plate 103. After assembly, pad shim 101 is coupled to backing plate 103. Pad shim 101 provides a tribological surface suitable for friction braking against a rotor of an automotive vehicle, while backing plate 103 provides a stiffer frame for brake operations to utilize to engage friction braking and to mount the brake pad assembly 100 within a set of braking calipers (or similar mounting position within a vehicle). Additional features of brake pad assembly 100 are illustrated in additional illustrations.

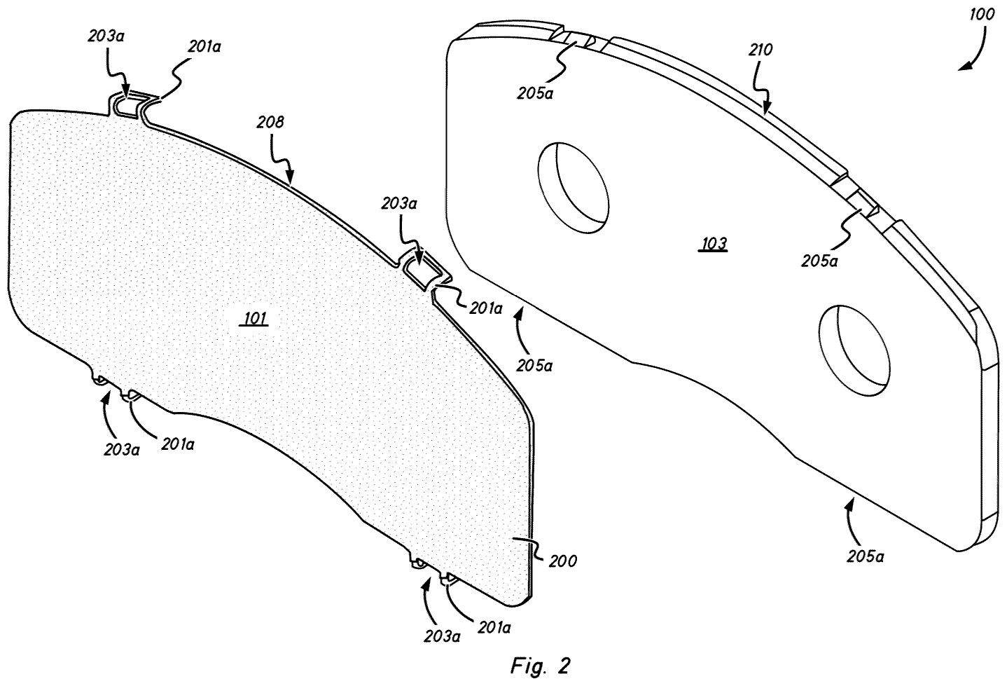

FIG. 2 is an exploded view of brake pad assembly 100, with additional features illustrated. Pad shim 101 comprises a body 200 and a number of snap latches 201 extending from body 200. Each of snap latches 201 defines a recess 203 having a first geometric shape. Backing plate 103 additionally comprises a matching number of latch catches 205, each exhibiting a second geometric shape. Each snap latch 201 engages a corresponding latch catch 205 during coupling of pad shim 101 and backing plate 103. The engagement of each latch catch 201 with the corresponding latch catch 205 is achieved by the latch catch 205 being threaded through the associated recess 203 during coupling. In the depicted embodiment, the shapes of snap latches 201, including the first geometric shape of recess 203, may be achieved during manufacture of pad shim 101, such as during a stamping process, molding process, casting process, cutting process, or any other method of manufacture known by one of ordinary skill without deviating from the teachings disclosed herein. In the depicted embodiment, the shapes of latch catches 205 may be achieved during manufacture of backing plate 103, such as during a stamping process, molding process, casting process, cutting process, or any other method of manufacture known by one of ordinary skill without deviating from the teachings disclosed herein.

Advantageously, because of the snap latches 201 and the latch catches 205 of brake pad assembly 100, pad shim 101 may be coupled to backing plate 103 without requiring an expensive or energy-intensive machining process. In some embodiments, the coupling of pad shim 101 and backing plate 103 may be accomplished by hand or using hand tools. Other embodiments may utilize other tools or methods of coupling pad shim 101 and backing plate 103 without deviating from the teachings disclosed herein. In an additional advantage, replacement of pad shim 101 may be performed by hand or with hand tools as well, which permits re-use of a backing plate 103 to be coupled with a replacement pad shim 101 after an initial shim has been expended by normal wear and tear. This advantageously permits lower production costs by minimizing the amount of materials and time needed to manufacture and assemble a working brake pad assembly 100, as the non-tribological materials can be re-utilized safely and effectively after pad shim 101 has been expended.

In the depicted embodiment, brake pad assembly 100 comprises a plurality of 4 snap latches 201 and a corresponding plurality of 4 latch catches 205, but other embodiments may comprise a different number without deviating from the teachings disclosed herein. In the depicted embodiment, the arrangement of the snap latches 201 and latch catches 205 exhibit symmetry with respect to a vertical bisection and horizontal bisection of brake pad assembly 100, but other embodiments may comprise different arrangements or configurations having different, additional, or no symmetry with respect to any measurement or dimension of brake pad assembly 100 without deviating from the teachings disclosed herein.

In the depicted embodiment, each of snap latches 201 extend from body 200 of pad shim 101 along an outer edge 208. Outer edge 208 is a perimeter surface of body 200 defining the outer shape of pad shim 101. Other embodiments may comprise other placements of snap latches 201 without deviating from the teachings disclosed herein.

In the depicted embodiment, each of latch catches 205 extend from an outer edge 210 of backing plate 103. Outer edge 210 is a perimeter surface of backing plate 103 defining the outer shape of backing plate 103. Other embodiments may comprise other placements of latch catches 205 without deviating from the teachings disclosed herein.

In the depicted embodiment, each of recesses 203 comprises a configuration of a recess 203a exhibiting a first geometric shape of a rectangle. Additionally in the depicted embodiment, each of the latch catches 205 exhibits a second geometric shape in the form of a wedge. Other embodiments may comprise different geometric shapes for one or more of the recesses 203 or latch catch 205 without deviating from the teachings disclosed herein.

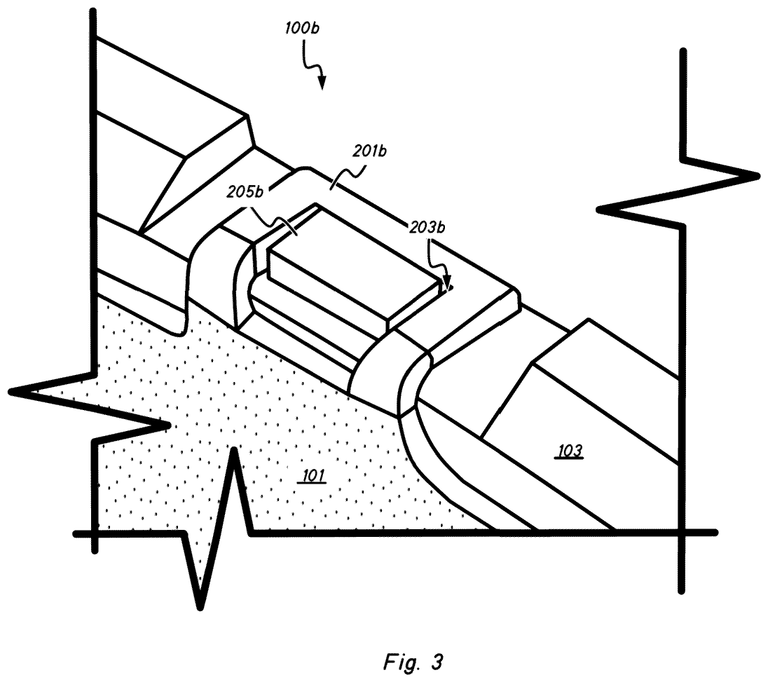

FIG. 3 is a close-up illustration of an alternate embodiment of brake pad assembly 100b, which has different geometric shapes for its snap latches 201 and latch catch 205. In this embodiment, the first geometric shape of the recess 203b defines a rectangle shape, and the corresponding second geometric shape of the latch catch 205b is also a rectangle.

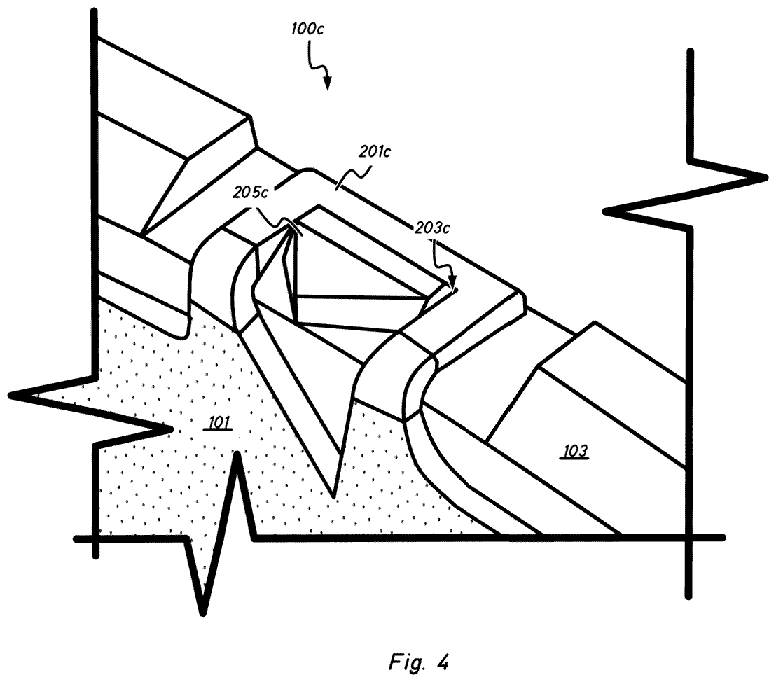

FIG. 4 is a close-up illustration of an alternate embodiment of brake pad assembly 100c, which has different geometric shapes for its snap latches 201 and latch catch 205. In this embodiment, the first geometric shape of the recess 203c defines a triangle shape, and the corresponding second geometric shape of the latch catch 205b is also a triangle.

FIG. 5 is a close-up illustration of an alternate embodiment of brake pad assembly 100d, which has different geometric shapes for its snap latches 201 and latch catch 205. In this embodiment, the first geometric shape of the recess 203d defines a circle shape, and the corresponding second geometric shape of the latch catch 205d is also a circle.

In some embodiments, the first geometric shape of snap latch 201 may be different in dimension or arrangement than the corresponding second geometric shape of latch catch 205 without deviating from the teachings disclosed herein. By way of example, and not limitation, the first geometric shape may define a rectangle, square, triangle, circle, half-circle or partial circle, oval, oblate pseudo-circle, regular polygon, irregular polygon, or any other defined shape recognized by one of ordinary skill in the art without deviating from the teachings disclosed herein. By way of example, and not limitation, the second geometric shape may define a rectangle, prism, square, cube, triangle, pyramid, wedge, circle, half-circle or partial circle, cylinder, oval, solenoid, oblate pseudo-circle, regular polygon, irregular polygon, or any other defined shape recognized by one of ordinary skill in the art without deviating from the teachings disclosed herein. In such embodiments, any of the first geometric shapes may be paired with any of the second geometric shapes without limitation, provided that the latch catch 205 is sufficiently sized and arranged to engage with the corresponding recess 203.

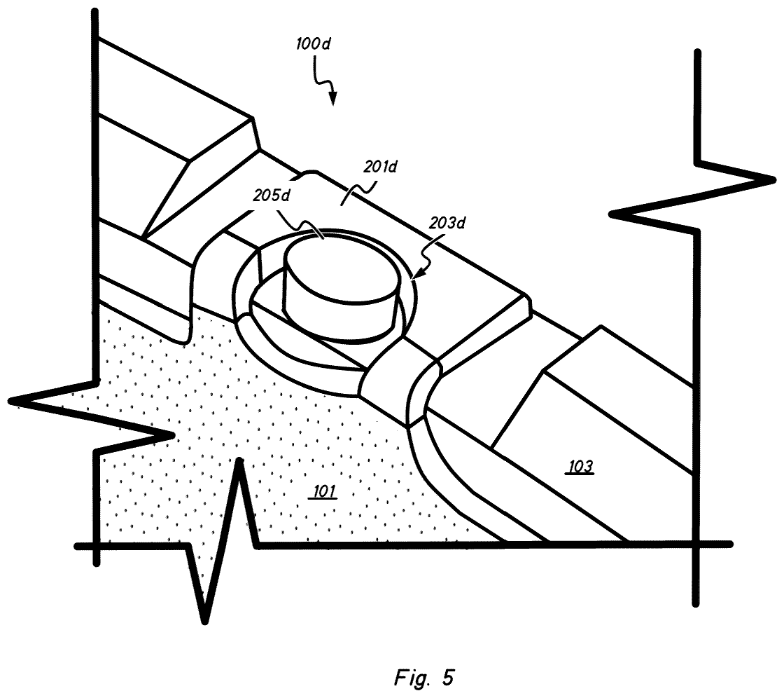

FIG. 6 is an illustration of a brake pad assembly 600. Brake pad assembly 600 comprises a pad shim 601 and a backing plate 603. After assembly, pad shim 601 is coupled to backing plate 603. Pad shim 601 provides a tribological surface suitable for friction braking against a rotor of an automotive vehicle, while backing plate 603 provides a stiffer frame for brake operations to utilize to engage friction braking and to mount the brake pad assembly 600 within a set of braking calipers (or similar mounting position within a vehicle). Additional features of brake pad assembly 600 are illustrated in additional illustrations.

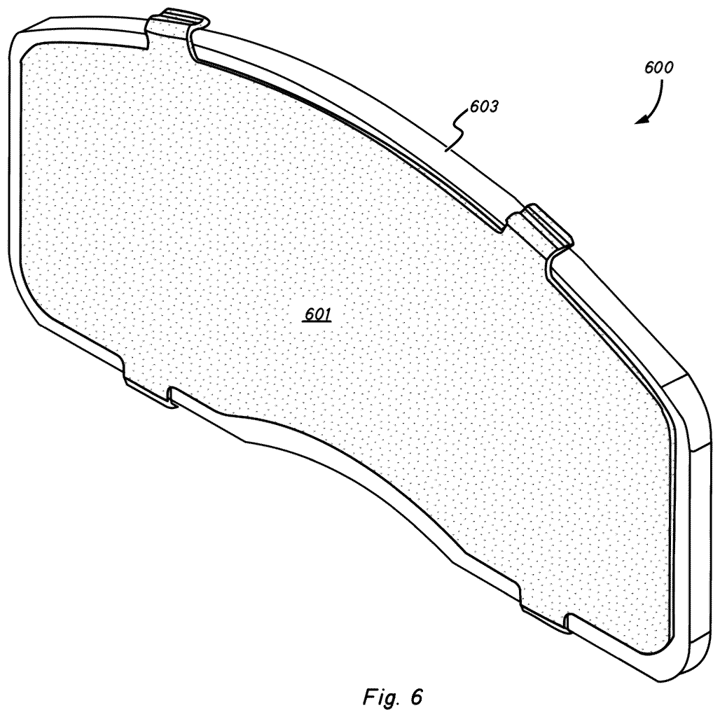

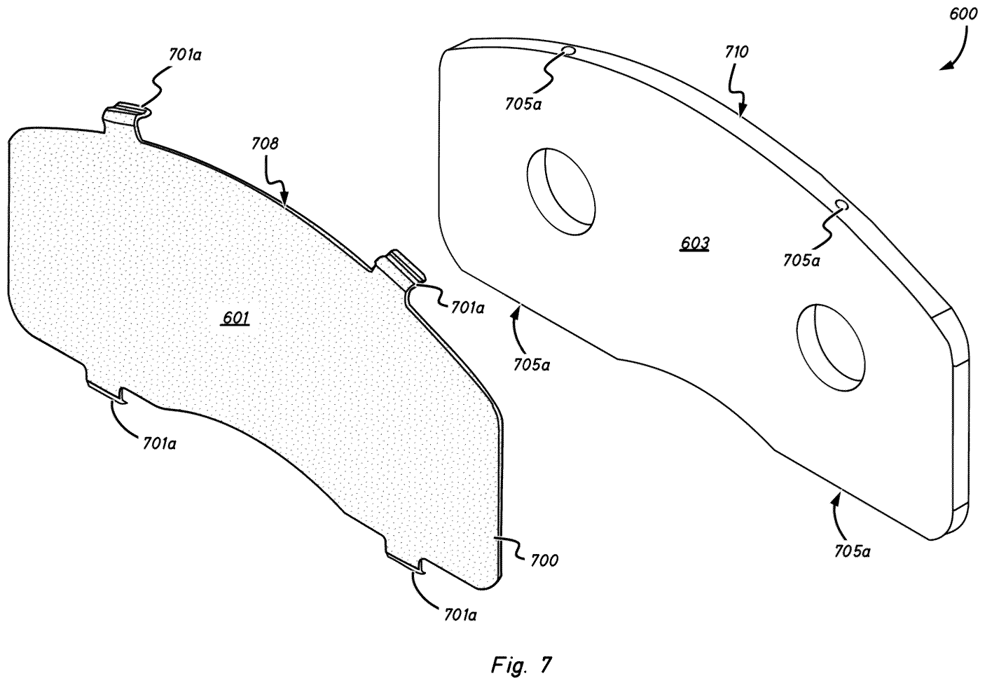

FIG. 7 is an exploded view of brake pad assembly 600, with additional features illustrated. Pad shim 601 comprises a body 700 and a number of springform tabs 701 extending from body 700. Each of snap latches 201 comprises a protrusion (not shown; see later figures) having a first geometric shape. Backing plate 603 additionally comprises a matching number of tab recesses 705, each exhibiting a second geometric shape. Each springform tab 701 engages a corresponding tab recess 705 during coupling of pad shim 601 and backing plate 603. The engagement of each springform tab 701 with the corresponding tab recess 605 is achieved by the protrusion being threaded through the associated tab recess 703 during coupling. In the depicted embodiment, the shapes of springform tabs 701, including the first geometric shape of the associated protrusions, may be achieved during manufacture of pad shim 601, such as during a stamping process, molding process, casting process, cutting process, or any other method of manufacture known by one of ordinary skill without deviating from the teachings disclosed herein. In the depicted embodiment, the shapes of tab recesses 705 may be achieved during manufacture of backing plate 603, such as during a stamping process, molding process, casting process, cutting process, or any other method of manufacture known by one of ordinary skill without deviating from the teachings disclosed herein.

Advantageously, because of the springform tabs 701 and the tab recesses 705 of brake pad assembly 600, pad shim 601 may be coupled to backing plate 603 without requiring an expensive or energy-intensive machining process. In some embodiments, the coupling of pad shim 601 and backing plate 603 may be accomplished by hand or using hand tools. Other embodiments may utilize other tools or methods of coupling pad shim 601 and backing plate 603 without deviating from the teachings disclosed herein. In an additional advantage, replacement of pad shim 601 may be performed by hand or with hand tools as well, which permits re-use of a backing plate 603 to be coupled with a replacement pad shim 601 after an initial shim has been expended by normal wear and tear. This advantageously permits lower production costs by minimizing the amount of materials and time needed to manufacture and assemble a working brake pad assembly 600, as the non-tribological materials can be re-utilized safely and effectively after pad shim 601 has been expended.

In the depicted embodiment, each of springform tabs 701 exhibit a spring-like force when pad shim 601 is coupled to backing plate 603. This spring-like force acts as a compressive force during coupling that advantageously assists in the engagement of the protrusion with its associated tab recess 705.

In the depicted embodiment, brake pad assembly 600 comprises a plurality of 4 springform tabs 701 and a corresponding plurality of 4 tab recesses 705, but other embodiments may comprise a different number without deviating from the teachings disclosed herein. In the depicted embodiment, the arrangement of the springform tabs 701 and tab recesses 705 exhibit symmetry with respect to a vertical bisection and horizontal bisection of brake pad assembly 600, but other embodiments may comprise different arrangements or configurations having different, additional, or no symmetry with respect to any measurement or dimension of brake pad assembly 600 without deviating from the teachings disclosed herein.

In the depicted embodiment, each of springform tabs 701 extend from body 600 of pad shim 601 along an outer edge 708. Outer edge 708 is a perimeter surface of body 700 defining the outer shape of pad shim 601. Other embodiments may comprise other placements of springform tabs 701 without deviating from the teachings disclosed herein.

In the depicted embodiment, each of tab recesses 705 are defined along an outer edge 710 of backing plate 603. Outer edge 710 is a perimeter surface of backing plate 603 defining the outer shape of backing plate 603. Other embodiments may comprise other placements of tab recesses 705 without deviating from the teachings disclosed herein.

In the depicted embodiment, each of the protrusions of springform tabs 701 may comprises a configuration exhibiting a first geometric shape of a cylinder. Additionally in the depicted embodiment, each of the tab recesses 705 exhibits a second geometric shape in the form of a circle. Other embodiments may comprise different geometric shapes for one or more of the springform tab 701 protrusions or tab recesses 705 without deviating from the teachings disclosed herein.

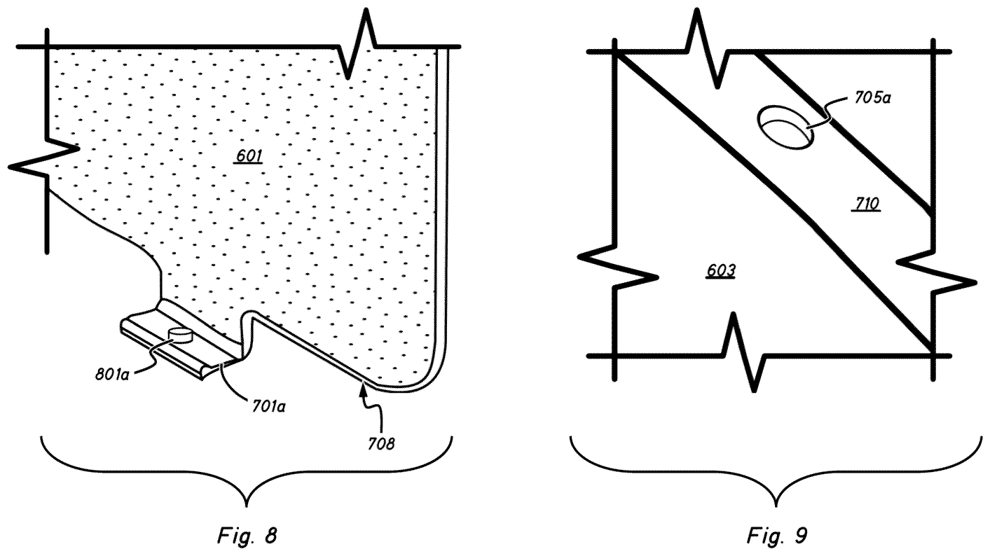

In the depicted embodiment, each of the springform tabs 701 comprise a first configuration thereof in the form of a springform tab 701a. FIG. 8 is a close-up illustration of a portion of pad shim 601 showing additional features of springform tab 701a. In the depicted embodiment, the associated protrusion 801a is visible, and the first geometric shape comprises a circle and cylinder. FIG. 9 is a close-up illustration of the associated tab recess 705, being configured as tab recess 705a, which defines a second geometric shape of a circle suitable to receive protrusion 801a. During coupling of pad shim 601 and backing plate 603, tab recess 705a receives protrusion 801a, and the matching cross-sectional shape advantageously provides optimized retaining force for the coupling.

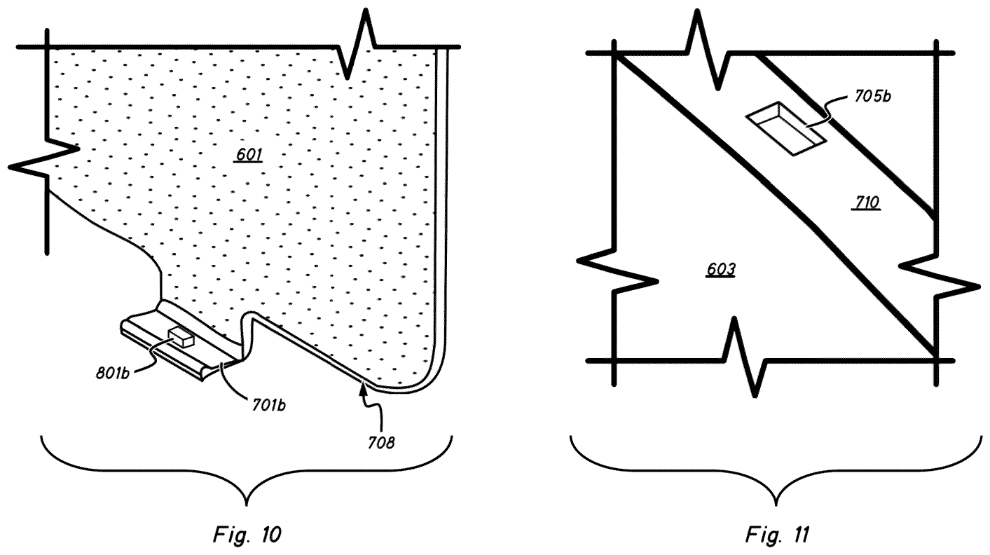

Other configurations may be utilized without deviating from the teachings disclosed herein. FIG. 10 is a close-up illustration of a portion of pad shim 601 showing additional features of an alternative embodiment of springform tab 701b. In the depicted embodiment, the associated protrusion 801b is visible, and the first geometric shape comprises a prism having a rectangle cross-section. FIG. 11 is a close-up illustration of the associated tab recess 705b which defines a second geometric shape of a rectangle suitable to receive protrusion 801b. During coupling of pad shim 601 and backing plate 603, tab recess 705b receives protrusion 801b, and the matching cross-sectional shape advantageously provides optimized retaining force for the coupling.

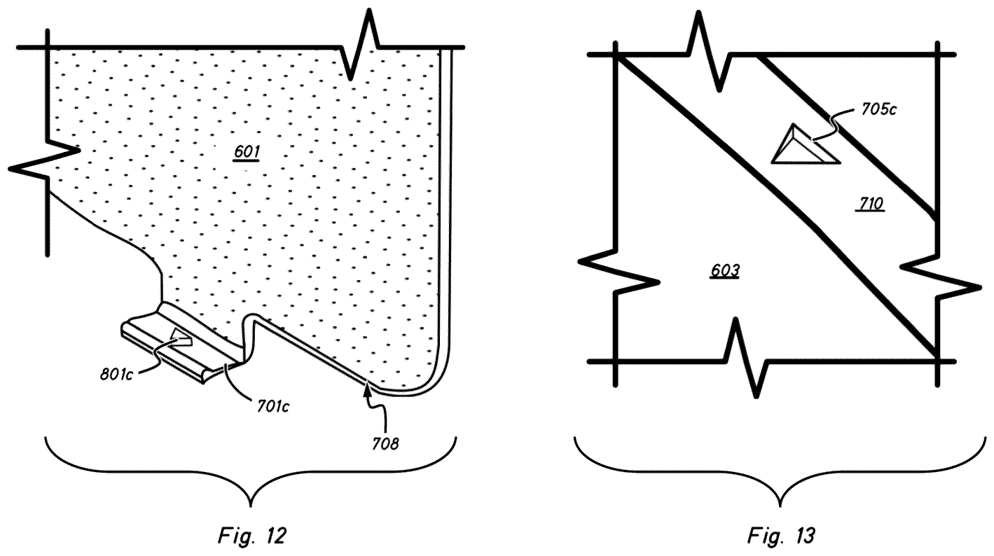

Additional configurations may be utilized without deviating from the teachings disclosed herein. FIG. 12 is a close-up illustration of a portion of pad shim 601 showing additional features of an alternative embodiment of springform tab 701c. In the depicted embodiment, the associated protrusion 801c is visible, and the first geometric shape comprises a polygon having a triangle cross-section. FIG. 13 is a close-up illustration of the associated tab recess 705c which defines a second geometric shape of a triangle suitable to receive protrusion 801c. During coupling of pad shim 601 and backing plate 603, tab recess 705c receives protrusion 801c, and the matching cross-sectional shape advantageously provides optimized retaining force for the coupling.

In some embodiments, the first geometric shape of protrusion 801 may be different in dimension or arrangement than the corresponding second geometric shape of tab recess 705 without deviating from the teachings disclosed herein. By way of example, and not limitation, the first geometric shape may define a rectangle, square, triangle, circle, half-circle, partial circle, oval, oblate pseudo-circle, regular polygon, irregular polygon, or any other defined shape recognized by one of ordinary skill in the art without deviating from the teachings disclosed herein. By way of example, and not limitation, the second geometric shape may define a rectangle, prism, square, cube, triangle, pyramid, wedge, circle, half-circle, partial circle, cylinder, oval, solenoid, oblate pseudo-circle, regular polygon, irregular polygon, or any other defined shape recognized by one of ordinary skill in the art without deviating from the teachings disclosed herein. In such embodiments, any of the first geometric shapes may be paired with any of the second geometric shapes without limitation, provided that the protrusion 801 is sufficiently sized and arranged to engage with the corresponding tab recess 705.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A brake pad assembly comprising:
a pad shim having a body and a springform tab extending from the body; and
a backing plate,
wherein
the springform tab defines a protrusion with a first geometric shape,
the backing plate comprises a tab recess with a second geometric shape,
wherein
the pad shim is coupled to the backing plate by engaging the protrusion with the tab recess, such that the tab recess receives the protrusion.

2. The brake pad assembly of claim 1, wherein the springform tab extends from an outer edge of the pad shim.

3. The brake pad assembly of claim 1, wherein the tab recess is defined along an outer edge of the backing plate.

4. The brake pad assembly of claim 1, wherein the springform tab directs a tensile force against the tab recess when the protrusion engages the tab recess.

5. The brake pad assembly of claim 1, wherein the pad shim has a plurality of springform tabs extending from the body and the backing plate has a matching plurality of tab recesses.

6. The brake pad assembly of claim 1, wherein the pad shim has 4 springform tabs extending from the body and the backing plate has 4 matching tab recesses.

7. The brake pad assembly of claim 6, wherein placement of the 4 springform tabs is symmetrical with respect to at least one dimension of the pad shim and wherein the placement of the 4 tab recesses is symmetrical with respect to at least one dimension of the backing plate.

8. The brake pad assembly of claim 1, wherein the first geometric shape is a circle.

9. The brake pad assembly of claim 1, wherein the second geometric shape is a circle.

10. The brake pad assembly of claim 1, wherein the first geometric shape is a rectangle.

11. The brake pad assembly of claim 1, wherein the second geometric shape is a rectangle.

12. The brake pad assembly of claim 1, wherein the first geometric shape is a triangle.

13. The brake pad assembly of claim 1, wherein the second geometric shape is a triangle.

14. The brake pad assembly of claim 1, wherein the tab recess is formed during a stamping process during manufacture of the backing plate.

15. The brake pad assembly of claim 1, wherein the springform tab is formed during a stamping process during manufacture of the backing plate.
